(19) United States
(12) Patent Application Publication
(10) Pub. No.: US 2023/0107959 A1
(43) Pub. Date: Apr. 6, 2023

(54) Self-Balancing Tool Holder or Material Removal Machine

(71) Applicant: David W. Buchberger, Wildomar, CA (US)

(72) Inventor: David W. Buchberger, Wildomar, CA (US)

(21) Appl. No.: 17/897,680

(22) Filed: Aug. 29, 2022

Related U.S. Application Data
(60) Provisional application No. 63/252,502, filed on Oct. 5, 2021.
(60) Provisional application No. 63/289,514, filed on Dec. 14, 2021.

(51) Int. Cl. B23B 31/00

(52) U.S. Cl. CPC B23B 31/006

(57) ABSTRACT

Improvements in a self-balancing tool holder or material removal machine that allows for greater accuracy of material removal. The balancer is able to self-adjust, any changes in the assembly are automatically adjusted. The adjustment can account for tool wear, accumulation of debris on the tool and balancing at different speeds of rotation. The tool holder balancer can be a mechanical fastener, shrink fit or bonding to the tool holder or material removal machine. The balancer uses a plurality of balls or any form of movable weight in the ring to provide the balance. The plurality of balls or media can freely move around the inside of the ring to offset any imbalance. The balls roll or spin to unique positions to provide a dynamic balance. The number and size of balls or weighted media is selected based upon the maximum amount of dynamic balancing that is required.

### CROSS REFERENCE TO RELATED APPLICATIONS

This application claims the benefit of Provisional Application Serial Number 63/252,502 filed Oct. 5, 2021, and Provisional Application Serial Number 63/289,514 filed Dec. 14, 2021, the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in balancing a machining tool. More particularly, the present tool holder or material removal machine includes a ring that contains a plurality of suspended balls, oil and weighted media and oil that dynamically balance the tool holder and a secured milling tool as well as the entire rotating assembly.

Description of Related Art including information disclosed under 37 CFR 1.97 and 1.98.

When a milling, or other metal machining tool with a spinning cutting tool is used, rotational balance of the cutting tool is critical for high precision removal of the material that is being machined. In addition to improved accuracy, rotational balance of the cutting tool will increase the bearing life of the machining apparatus, reduce tool wear, increase surface finish quality and accuracy. The first method is to balance the cutting tool and the tool holder. With the tool holder and the cutting tool balanced there is still some imbalance when the two parts are joined together to to remove material. The rotational position of the cutting tool within the tool holder changes the position of the balance every time a new tool is locked into the milling machine.

A number of patents and or publications have been made to address these issues. Exemplary examples of patents and or publication that try to address this /these problem(s) are identified and discussed below.

U.S. Pat. No. 9,822,477 issued on Nov. 21, 2017, to Donald E. Erickson and is titled Balance Ring Assembly. This patent discloses a balance ring assembly for balancing a liquid holding tub that is rotatable about an axis of rotation in a laundry treating appliance, includes an enclosed annular housing having a hollow annular raceway and a longitudinal axis, a magnetic mass disposed in the hollow annular raceway and movable therein, and a magnet mounted to the annular housing. While it discloses a balancing ring the ring is not configured or discloses for use with a milling machine.

U.S. Pat. No. 8,286,531 issued on Oct. 16, 2012, to David Michael Jones et al., and is titled Automatic Balancing Device. This patent discloses an automatic balancing device for counterbalancing an out-of-balance mass includes a plurality of counterbalancing masses, each of which is movable in a circular path about the axis so as to generate a balancing force. The balancing forces combine to produce a resultant balancing force which varies between minimum and maximum values. The device allows at least partial counterbalancing of the out-of-balance mass at speeds below the critical speed of the system in which it is used. While this patent discloses an automatic balancing device the device is not configured for use on a machining tool or holder.

U.S. Pat. No. 4,787,132 issued on Nov. 29, 1988, to Ronald B. Kilgore and is titled Method of Making dynamic Rotational Counterbalance Structure. This patent discloses a dynamic rotational counterbalance structure includes a discoid balance body having a groove or race formed in an outer circumferential surface of the body. A plurality of movable weights such as spherical weights are positioned in the groove along with a lubricating and noise damping fluid. The groove is closed by an outer circumferential band. At least two of the balance structures are affixed coaxially on a rotatably member to be balanced. While this patent discloses a rotational counterbalance structure the structure is not configured for use in a milling machine.

What is needed is a dynamic device that used multiple constrained balls or other weighted media to balance a combination of a machining tool and a cutting bit holder. The proposed self-balancing tool holder disclosed in this application provides the solution.

### BRIEF SUMMARY OF THE INVENTION

It is an object of the self-balancing tool holder or material removal machine to provide dynamic balancing to a tool holder that can dynamically balance the cutting tool and tool holder. Because the balancer is able to self-adjust, any changes in the assembly are automatically adjusted. The adjustment can account for tool wear, accumulation of debris on the tool and balancing at different speeds of rotation. Indexing and positioning of the tool holder in the chuck or collet can alter the balance and the tool holder is able to dynamically adjust to balance the tool holder and cutting tool to improve the accuracy.

It is an object of the self-balancing tool holder or material removal machine to be configured in a ring that can be installed on an existing tool holder or can be designed into a tool holder. The tool holder balancer can be a mechanical fastener, shrink fit or bonding. The ring configuration fits with the circular, cylindrical and conical shape of the tool holder. The size of the ring is designed based upon the size of balancing balls and tool holder.

It is another object of the self-balancing tool holder or material removal machine to reduce some of the tool balancing by addition of weights or the removal of some material from the tool holder. This procedure often requires expensive equipment and a procedure to ensure the tool holder is balanced prior to use in a milling or CNC (Computer Nematic Control) machine. It also requires significant time and skilled labor.

It is another object of the self-balancing tool holder or material removal machine to use a plurality of balls or any other weighted medial and oil in the ring to provide the balance. The plurality of balls or media can freely move around the inside of the ring to offset any imbalance. The balls, or other weighted media, roll, move or spin to unique positions to provide a dynamic balance. The number and size of balls is selected based upon the maximum amount of dynamic balancing that is required for the imbalance of the assembly of the tool holder and milling cutter along with any fasteners such as set screws.

It is still another object of the self-balancing tool holder or material removal machine to be able to design the position of the balancer for a location along the length of the tool holder to obtain optimal balancing of the tool holder and cutting tool. Balancers can also be placed on opposing ends of the tool holder to provide more even balancing of the tool holder and also account for some loading on the milling bit as it removes material. It is also possible to locate a balancer on the milling cutter to provide a further level of dynamic balancing.

It is still another object of the self-balancing tool holder or material removal machine to reduce vibration through oil contained alongside the weighted medial

It is still another object of the self-balancing ring to be an integral part of a spindle, headstock or other rotating part of a material removal machine. This allows the machine to dynamically balance the rotating or turning machine bit in a milling machine or part that is being machined as in a lathe.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S

FIG. 1 shows a prior art endmill in a tool holder.

FIG. 2 shows the tool holder with the dynamic balancer.

FIG. 3 shows a 750 EM tool holder with the dynamic balancer 30.

FIG. 4 shows the dynamic balancer shrink fit onto the end of the tool holder 40.

FIG. 5 shows a tool holder from FIG. 3 partially sectioned to show the dynamic balancing ring 60.

FIG. 6 shows the dynamic balancing ring 60.

FIG. 7 shows another embodiment of the dynamic balancer in a milling head.

FIG. 8 shoes the dynamic balancer in a milling head.

FIG. 9 shows the dynamic balancer on a lathe spindle.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

Item Numbers and Description

| | |
|---|---|
| 10 prior art endmill in holder | 15 divot |
| 14 set screw | 16 divots |
| 17 key | 18 end mill |
| 19 tool holder | 20 dynamically balanced tool holder |
| 21 bit hole | 22 tapered contact surface |
| 23 trapezium notch | 24 grip orientation notch |
| 25 drive slot | 26 shank |
| 27 bore for retention knob | 28 flat |
| 29 traverse shank | 30 tool holder |
| 40 tool holder | 41 tapered transverse shank |
| 42 fluid cooling holes | 43 step |
| 50 head stock | 51 tailstock |
| 52 part | 60 balancing ring |
| 61 balls | 62 outer race / ring |
| 69 second ring | 70 spindle |
| 71 inner /outer race separation | 72 half-ring separation |
| 73 upper / lower ring separation | |

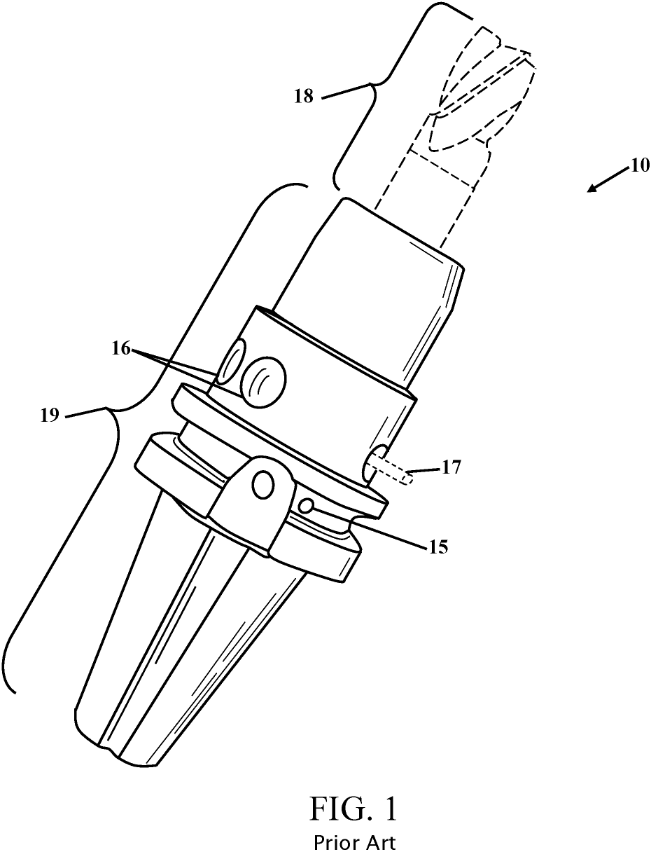

FIG. 1 shows a prior art endmill in a tool holder 10. This is the currently used method to balance a CNC, or equivalent, end mill 18, milling bit or cutter. This figure shows the endmill 18 secured within a tool holder 16. The endmill 18 is typically secured with a set screw or other locking feature with a key 17. After securing the endmill 18 the assembly is spun at an operating speed of the endmill, that is typically mathematically 25,000 RPM. A balancing apparatus identifies the location(s) and the amount of material needs to be removed from the tool holder 19. While weights could also be used for the balancing, material removal is the most common method for balancing and once the material is removed it can’t be re-applied to return the tool holder to an initial condition.

This figure shows divots 15 and 16 where material is removed. After removal of the material, the endmill and tool holder is re-spun to verify the balance or if additional material must be removed to provide an acceptable spin balance for the assembly of the tool holder 19 and the endmill 18. While this provides a balanced assembly at a spinning rate of 25,000 RPM, it is time consuming, and some factors can cause an imbalance as well as spinning the assembly at other speeds may not be balanced. While a spin rate of 25,000 RPM is a standard, material removal can be made at a different speed based upon the material that is being machined and the desired surface finish.

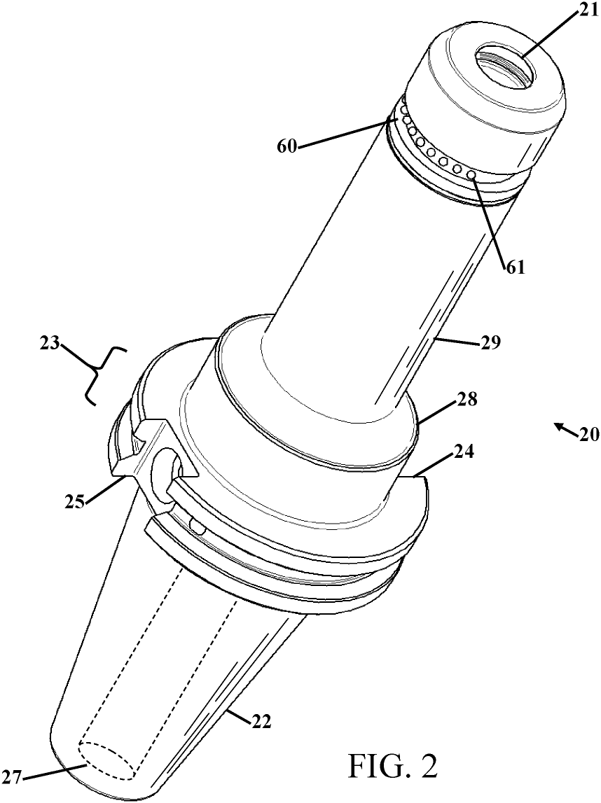

FIG. 2 shows the tool holder with the dynamic balancer 20. These figures show a first embodiment of the dynamic balancer 20 on a type ER16 tool holder. At one end of a typical tool holder has a bore for a retention knob 27. This end also has a tapered contact surface 22 that is tapered to a trapezium notch 23. Within the trapezium notch 23 is a grip orientation notch 24 and a drive slot 25. This figure shows the grip orientation notch 24 and the drive slot 25 on opposite sides of the trapezium notch 23, but they could be located at a different angular offset. The grip orientation notch in the prior art figure shows the grip orientation notch extending down the length of the tapered contact surface.

Above the trapezium notch 23 is a flat 28 with a traverse shank 29 where the cutting tool is secured therein a bit hole 21. In this embodiment, the transverse shank 29 has the balancing ring 60. Within the balancing ring 60 is a plurality of balls 61 that freely move around within the ring 60 to dynamically balance the turning tool holder 20. The minimum number of balls is three and the maximum number of balls is a quantity that fills less than 180 degrees of the ring 60. The ring 60 can be constructed as a left and a right half with the balls 61 suspended within the left and right half, or the ring 60 can be constructed as an inner ring and an outer ring with the balls 61 suspended therein between. It is further contemplated that the ring could be constructed as a left and a right half where the balls 61 are placed in one-half, placed in a recess in the traverse shank 29 and an empty second half is installed in the other side of the recess in the traverse shank 29.

The size and quantity of the balls 60 or weighted media can also be selected based upon the greatest amount of dynamic out-of-balance that is expected from the assembly of the tool holder with an installed tool. This embodiment places the balancing ring 60 in proximity to the milling bit to obtain an improved balance, as opposed to the removing material at or near the trapezium notch 23. While balls are shown and described in this document the balls can be other weighted media that roll, move or spin to unique positions to provide a dynamic balance. In addition to balls the weighted media can be roller bearings, carbide dust, steel dust, organic dust, weighted gel, magnetic powder, rotating magnet, liquids including oil or any other media that can move within the tool holder to offset the imbalance of the tool or machine.

Removal of material is a destructive method to balance the tool holder because the removed material can’t be re-applied to balance the tool holder. Future balancing can only be obtained by additional material removal.

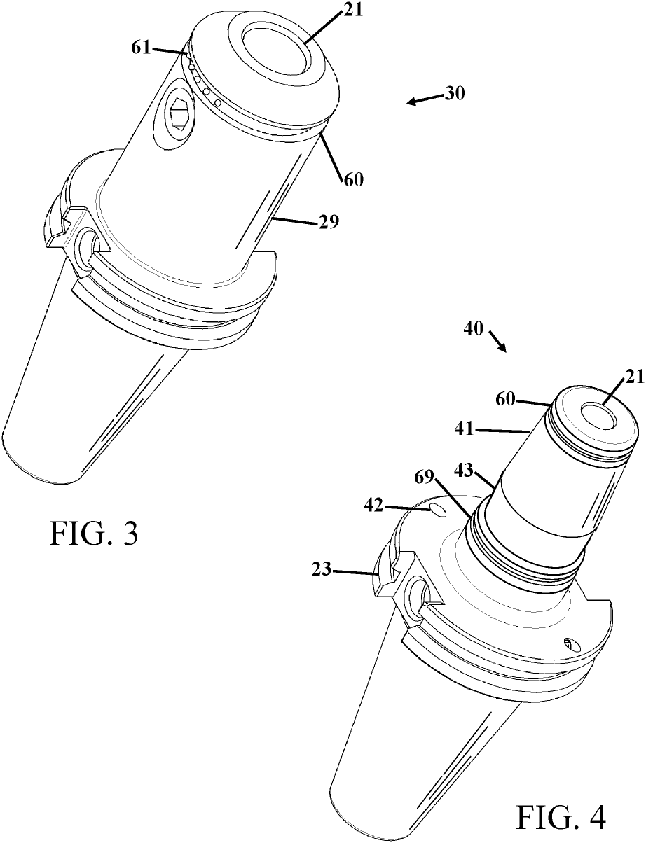

FIG. 3 shows a 750 EM tool holder 30 with the dynamic balancer. From this figure the bit hole 21 is at the upper end of the tool holder 30 with the dynamic balancing ring 60. In this embodiment the dynamic balancing ring 60 is at the uppermost end of the traverse shank of the tool holder so the balls 61 have the greatest effect to balance the cutting tool (not present in this figure). The dynamic balancing ring 60 balances an empty tool holder and the combination of the tool holder with a cutting bit secured therein. The balls 61 can freely move around within the ring 60 to balance the rotational concentricity.

FIG. 4 shows the dynamic balancer ring 60 is shrink fit onto the end of the tool holder 40. In this embodiment, the balancing ring 60 is also located near the bit hole 21. The transverse shank is a tapered transverse shank 41. This embodiment also shows an optional second ring 69 placed near the trapezium notch 23. The tapered transverse shank 41 has a step 43 where the optional second ring 69 is set or heat shrunk onto the transverse shank. This tool holder 40 is configured with one or a plurality of fluid cooling holes 42 for cooling the milling bit. Movement of the balls within the balancing ring(s) can offset any imbalance of fluid within the toll holder that could be caused by air bubbles.

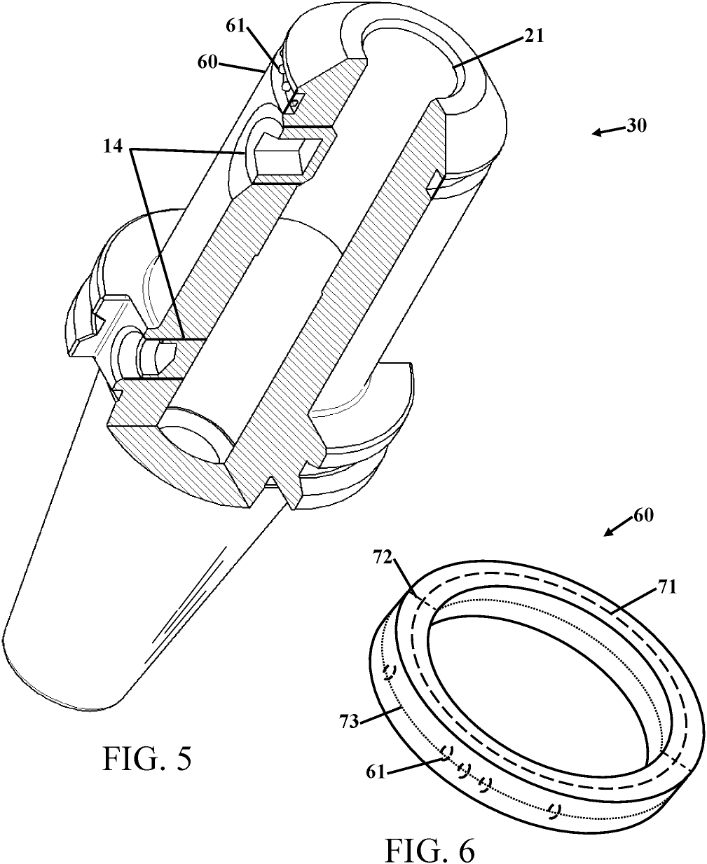

FIG. 5 shows a tool holder from FIG. 3 partially sectioned to show the dynamic balancing ring 60. From this sectional figure the ring 60 with the balls 61 are shown integrated into the tool holder 30. A mill or machining bit is placed within bit hole 21 of the tool holder and is secured within the traverse shank 29 the tool holder with set screws 14 or other securing mechanism.

FIG. 6 shows the dynamic balancing ring 60. This figure shows the basic balancing ring 60 with the balls 61 suspended within the ring and free to move within the ring to balance any imbalance. Three different configurations of ring construction and splitting of the ring 60 are shown and ca be used depending upon the method of insertion of the ring on a tool holder.

The ring 60 can be constructed as a left and a right half-ring separation 72 split with the balls 61 suspended within the left and right half. This embodiment allows the dynamic balancing ring to fit within a groove in the tool holder body or the transverse shank. The ring 60 can be constructed as an inner ring and an outer ring race separation 71 with the balls 61 suspended therein between. This embodiment is the most common construction for a bearing. In a third method of construction shows an upper / lower ring separation 73 which can be used in a shrink fit installation. While shrink fit is used in this embodiment, other methods of securing the balancer are contemplated including, but not limited to shrink fit steel, shrink fit plastic screws, bolts, adhesive, welding, brazing, friction welding and threading onto the tool holder or machine.

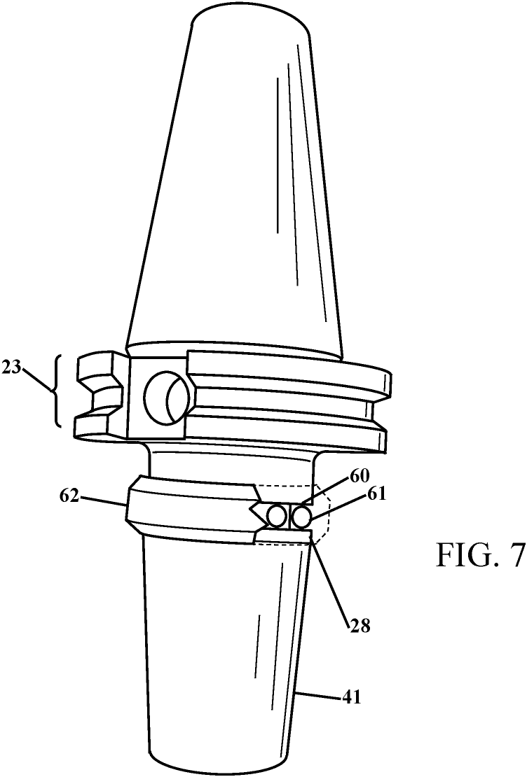

FIG. 7 shows another embodiment of the dynamic balancer in a milling head. In this embodiment an optional flat 28 area is formed on the tool holder below the trapezium notch 23 in the tapered transverse shank 41. A balancing ring 60 recess for the balls 61 is milled or otherwise formed into the tool holder. After the balls 61 are inserted into the recess the outer race / ring 62 is fitted over the balls 61 by a press-fit or other equivalent securing means / mechanism.

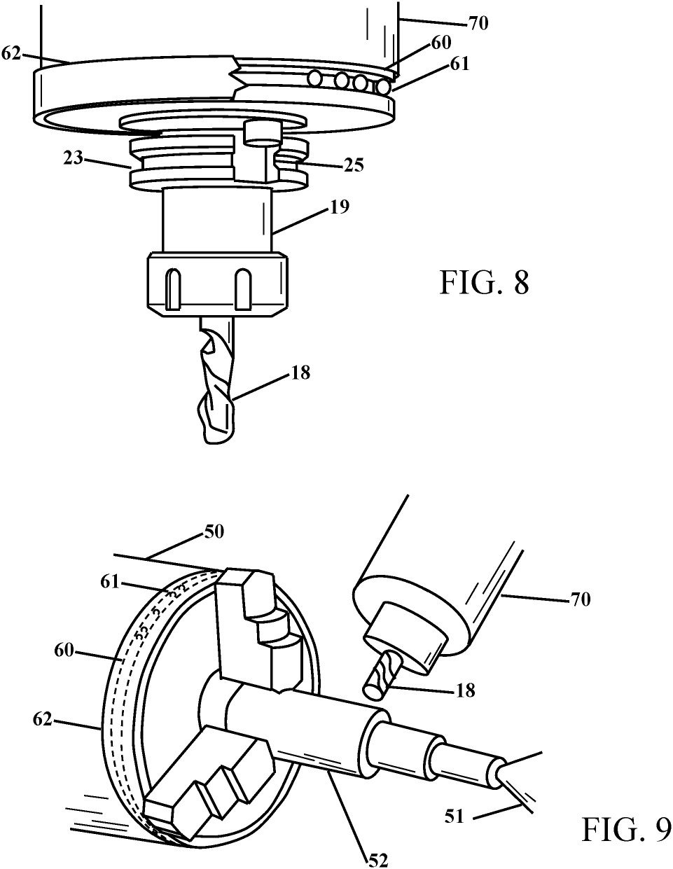

While some embodiments are shown in a tool holder 19, the balancing ring can also be integral to a mill spindle 70, lath, CNC machine or other material removal machine. FIG. 8 shoes the dynamic balancer in a milling head. In this embodiment, the spindle 70 of the machine has a balancing ring 60 formed in the end of the spindle 70 where the balls 61 can move around the recess. A tool holder 19 is also shown in the spindle 70 with the end mill 18 where the trapezium notch 23 of the tool holder 19 is indexed in the drive slot 25. After the balls 61 are inserted into the recess the outer race / ring 62 is fitted over the balls 61 by a press-fit or other equivalent securing means / mechanism to allow the balls 61 to move in the slot to dynamically balance the spindle 70.

FIG. 9 shows the dynamic balancer on a lathe spindle headstock 50. A part 52 is shown chucked in the headstock 50 and extends to the tailstock 51. An endmill 18 is shown on the spindle 70. While the spindle 70 is not shown with an integrated dynamic balancer, it could be installed as previously identified in the spindle 70 or in a tool holder for the endmill 18. The balancing ring 60 is integrated in the headstock 50 as a recess in the headstock 50. After the balls 61 are inserted into the recess the outer race / ring 62 is fitted over the balls 61 by a press-fit or other equivalent securing means / mechanism.

Various locations of the balancer are shown on the machine and / or the tool holder. While some specific locations are shown and described, it should be understood that the balancer can be placed inside, outside, at the end in a screw, in the retention knob, in the ER collet, in the Collet nut, inside the bladder as well as anywhere in the machine tool spindle as well. It is further contemplated that the balancer could be fabricated in the cutting or milling bit or endmill.

Thus, specific embodiments of a tool holder balancer have been disclosed. It should be apparent, however, to those skilled in the art that many more modifications besides those described are possible without departing from the inventive concepts herein. The inventive subject matter, therefore, is not to be restricted except in the spirit of the appended claims.

### SEQUENCE LISTING

Not Applicable.

1. A self-balancing tool holder comprising:
a tool holder;
a hollow ring containing a plurality of media that is secured to said tool holder;
said plurality of media being arranged to freely move within said hollow ring, and
said plurality of media are configured to move within said ring to dynamically balance said tool holder.

2. The self-balancing tool holder according to claim 1, wherein said plurality of media is at least three balls.

3. The self-balancing tool holder according to claim 2, wherein the number of balls is selected to fill less than half of the hollow ring.

4. The self-balancing tool holder according to claim 1, wherein said tool holder further includes a milling tool.

5. The self-balancing tool holder according to claim 1, wherein said dynamically balancing said tool holder is when said tool holder is being axially rotated.

6. The self-balancing tool holder according to claim 1, wherein said plurality of media is selected from a group comprising at least one of roller bearings, carbide dust, steel dust, organic dust, weighted gel, magnetic powder, rotating magnet, oil and liquid.

7. The self-balancing tool holder according to claim 1, wherein said hollow ring is secured to said tool holder by shrink fit steel, shrink fit plastic screws, bolts, adhesive, welding, brazing, friction welding or threading.

8. The self-balancing tool holder according to claim 1, wherein said hollow ring is secured to said tool holder inside said tool holder, outside of said tool holder, in or on a retention knob, in or on an ER collet, in or on a spindle or inside of a bladder.

9. The self-balancing tool holder according to claim 1, wherein said tool holder is configured for retention in a milling machine or a lath.

10. The self-balancing tool holder according to claim 1, wherein there is at least a second hollow ring containing a second plurality of media that is secured to said tool holder;
said second plurality of media being arranged to freely move within said second hollow ring independently from said plurality of media in said hollow ring, and
said second plurality of media are configured to move within said second ring to dynamically balance said tool holder.

11. A self-balancing material removal machine comprising:
a material removal machine having a tool holder;
a hollow ring containing a plurality of media that is secured to said material removal machine near said tool holder;
said plurality of media being arranged to freely move within said hollow ring, and
said plurality of media are configured to move within said ring to dynamically balance a material removal bit or endmill.

12. The self-balancing material removal machine according to claim 11, wherein said plurality of media is at least three balls.

13. The self-balancing material removal machine according to claim 12, wherein the number of balls is selected to fill less than half of the hollow ring.

14. The self-balancing material removal machine according to claim 11, wherein said tool holder further includes a milling tool.

15. The self-balancing material removal machine according to claim 11, wherein said dynamically balancing said material removal machine is when said tool holder is being axially rotated.

16. The self-balancing material removal machine according to claim 11, wherein said plurality of media is selected from a group comprising at least one of roller bearings, carbide dust, steel dust, organic dust, weighted gel, magnetic powder, rotating magnet, oil and liquid.

17. The self-balancing material removal machine according to claim 11, wherein said hollow ring is secured to said material removal machine by shrink fit steel, shrink fit plastic screws, bolts, adhesive, welding, brazing, friction welding or threading.

18. The self-balancing material removal machine according to claim 11, wherein said hollow ring is secured to said material removal machine inside said material removal machine, outside of said material removal machine.

19. The self-balancing material removal machine according to claim 11, wherein said material removal machine is a milling machine or a lath.

20. The self-balancing material removal machine according to claim 11, wherein there is at least a second hollow ring containing a second plurality of media that is secured to said material removal machine;
said second plurality of media being arranged to freely move within said second hollow ring independently from said plurality of media in said hollow ring, and
said second plurality of media are configured to move within said second ring to dynamically balance said material removal machine.
